(19) United States
(12) Patent Application Publication
(10) Pub. No.: US 2012/0268455 A1
(43) Pub. Date: Oct. 25, 2012

(54) IMAGE PROCESSING APPARATUS AND METHOD

(76) Inventors: Kenichi Shimoyama, Tokyo (JP); Takeshi Mita, Kanagawa (JP); Yoshiyuki Kokojima, Kanagawa (JP); Ryusuke Hirai, Tokyo (JP); Masahiro Baba, Kanagawa (JP)

(21) Appl. No.: 13/360,080

(22) Filed: Jan. 27, 2012

Related U.S. Application Data
(63) Continuation of application No. PCT/JP2011/059759, filed on Apr. 20, 2011.

(51) Int. Cl. G06T 15/00

(52) U.S. Cl. 345/419

(57) ABSTRACT

An image processing apparatus according to an embodiment includes a displaying device, a receiver, a calculator, and a controller. The displaying device can display a stereoscopic image. The receiver receives a start signal used for starting setting a viewing zone in which the stereoscopic image can be viewed by a viewer. The calculator calculates, on the basis of position information of the viewer, viewing zone information representing a position of the viewing zone when the start signal is received. The controller controls the displaying device so as to set the viewing zone corresponding to the viewing zone information.

### CROSS-REFERENCE TO RELATED APPLICATIONS

This application is a continuation of PCT international application Ser. No. PCT/JP2011/059759 filed on Apr. 20, 2011, which designates the United States; the entire contents of which are incorporated herein by reference.

### FIELD

Embodiments described herein relate generally to an image processing apparatus and a method.

### BACKGROUND

In stereoscopic image display apparatuses, a viewer can view a stereoscopic image with naked eyes without using special glasses. Such a stereoscopic image display apparatus displays a plurality of images having different viewpoints, and the light beams thereof are controlled, for example, by using a parallax barrier, a lenticular lens, or the like. The controlled light beams are guided to viewer's both eyes. If the viewer's viewing position is appropriate, the viewer can recognize a stereoscopic image. Such an area in which a viewer can view a stereoscopic image is called a viewing zone.

However, there is a problem in that such a viewing zone is limited. In other words, there is a reverse-viewing zone in which the viewpoint of an image recognized by the left eye is on the relatively right side, compared to the viewpoint of an image recognized by the right eye, which makes it difficult to correctly recognize a stereoscopic image.

Japanese Patent No. 3,443,271 and Japanese Patent No. 3,503,925 disclose conventional techniques for setting a viewing zone in accordance with the position of a viewer.

Japanese Patent No. 3,443,271 discloses a technique in which the viewer's position is detected by using a sensor, and the position of the viewing zone in accordance with the position of the viewer is implemented by interchanging a right-eye image and a left-eye image. In addition, Japanese Patent No. 3,503,925 discloses a technique in which a signal emitted from a remote control device is detected, and a display device is rotated in a direction in which the signal is emitted.

### BRIEF DESCRIPTION OF THE DRAWINGS

FIG. 1 is a diagram illustrating an image processing apparatus according to a first embodiment;

FIG. 2 is a diagram illustrating an example of a displaying device according to the first embodiment;

FIG. 3 is a diagram illustrating an example of a viewing zone according to the first embodiment;

FIG. 4 is a diagram illustrating the control of the viewing zone according to the first embodiment;

FIG. 5 is a diagram illustrating the control of the viewing zone according to the first embodiment;

FIG. 6 is a diagram illustrating the control of the viewing zone according to the first embodiment;

FIG. 7 is a diagram illustrating the control of the viewing zone according to the first embodiment;

FIG. 8 is a flowchart illustrating a display control process according to the first embodiment;

FIG. 9 is a diagram illustrating an image processing apparatus according to a second embodiment;

FIG. 10 is a flowchart illustrating a display control process according to the second embodiment;

FIG. 11 is a diagram illustrating an image processing apparatus according to a third embodiment;

FIG. 12 is a flowchart illustrating a display control process according to the third embodiment;

FIG. 13 is a diagram illustrating an image processing apparatus according to a fourth embodiment; and

FIG. 14 is a flowchart illustrating a display control process according to the fourth embodiment.

### DETAILED DESCRIPTION

In general, an image processing apparatus according to an embodiment includes a displaying device, a receiver, a calculator, and a controller. The displaying device can display a stereoscopic image. The receiver receives a start signal used for starting setting a viewing zone in which the stereoscopic image can be viewed by a viewer. The calculator calculates, on the basis of position information of the viewer, viewing zone information representing a position of the viewing zone when the start signal is received. The controller controls the displaying device so as to set the viewing zone corresponding to the viewing zone information.

### First Embodiment

An image processing apparatus 10 of a first embodiment is suitable for a television (TV) set, a personal computer (PC), and the like that enable a viewer to view a stereoscopic image with the unaided eye. The stereoscopic image is an image that includes a plurality of parallax images having parallax therebetween.

Incidentally, an image described in the embodiments may be a still image or a moving image.

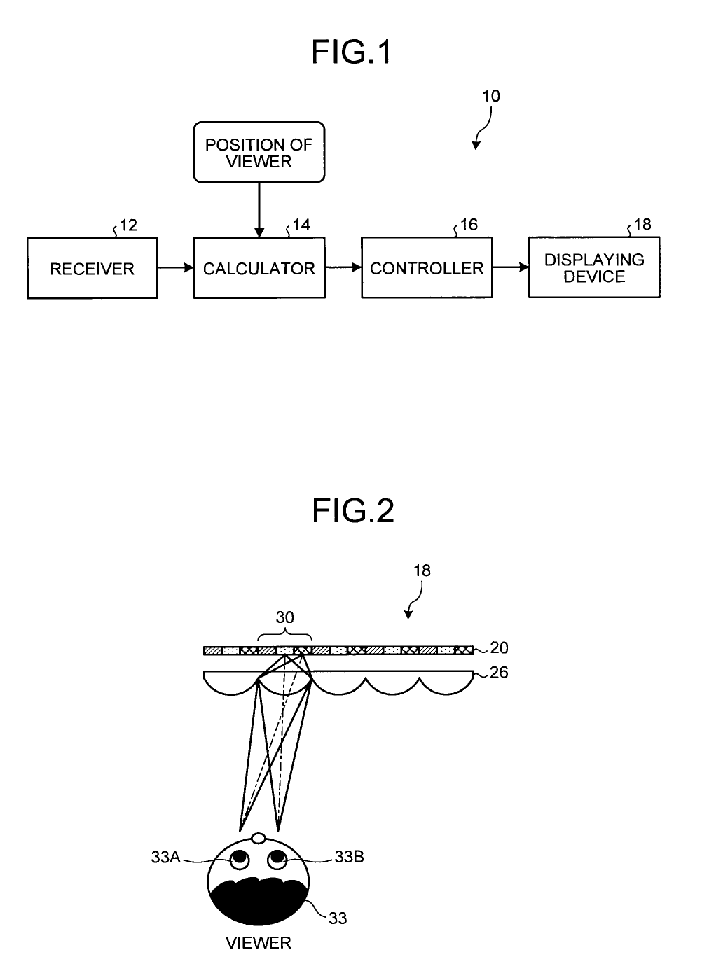

FIG. 1 is a block diagram illustrating the functional configuration of the image processing apparatus 10. The image processing apparatus 10 can display a stereoscopic image. The image processing apparatus 10, as illustrated in FIG. 1, includes a receiver 12, a calculator 14, a controller 16, and a displaying device 18.

The receiver 12 receives a start signal used for starting setting a viewing zone within which one or a plurality of viewers can view the stereoscopic image. The receiver 12 may receive the start signal from an external device (not illustrated in the figure) that is connected to the receiver 12 in a wired or wireless manner. As such an external device, for example, there is a remote control device, an information terminal, or other known devices. The receiver 12 supplies the received start signal to the calculator 14.

The viewing zone represents a range in which a viewer can view a stereoscopic image displayed on the displaying device 18. This viewable range is a range (region) in a real space. This viewing zone is set on the basis of a combination of display parameters (described later in detail) of the displaying device 18. Accordingly, the viewing zone can be determined by settings of the display parameters of the displaying device 18.

The displaying device 18 is a display device that displays a stereoscopic image. As illustrated in FIG. 2, the displaying device 18 includes a display element 20 and an opening controller 26. A viewer 33 views a stereoscopic image displayed on the displaying device 18 by viewing the display element 20 through the opening controller 26.

The display element 20 displays parallax images used for displaying a stereoscopic image. Examples of the display element 20 include a direct-viewing type two-dimensional display such as an organic electroluminescence (EL), a liquid crystal display (LCD), and a plasma display panel (PDP), and a projection-type display.

The display element 20 may have a known configuration in which sub pixels of colors, for example, RGB are arranged in matrix, where R, G, and B colors constitute one pixel. In this case, each of the sub pixels of the colors RGB aligned in a first direction configures one pixel, and an image displayed in a pixel group, in which adjacent pixels corresponding to the number of parallaxes are aligned in a second direction intersecting the first direction, is referred to as an element image 30. The first direction, for example, is a column direction (vertical direction), and the second direction, for example, is a row direction (horizontal direction). The arrangement of the sub pixels of the display element 20 may be another known arrangement. In addition, the colors of the sub pixels are not limited to the three colors RGB. For example, the number of the colors of the sub pixels may be four.

The opening controller 26 outputs light beams emitted from the display element 20 toward the front side thereof through opening portions in a predetermined direction. As the opening controller 26, there is a lenticular lens, a parallax barrier, or the like.

The opening portions of the opening controller 26 are arranged so as to be in correspondence with the element images 30 of the display element 20. When a plurality of the element images 30 are displayed in the display element 20, a parallax image group (multiple-parallax images) corresponding to the direction of a plurality of parallaxes is displayed in the display element 20. The light beams according to the multi-parallax images are transmitted through the opening portions of the opening controller 26. In addition, the viewer 33 positioned within the viewing zone views different pixels included in the element image 30 with the left eye 33A and the right eye 33B. Thus, by displaying images having different parallaxes for the left eye 33A and the right eye 33B of the viewer 33, the viewer 33 can view a stereoscopic image.

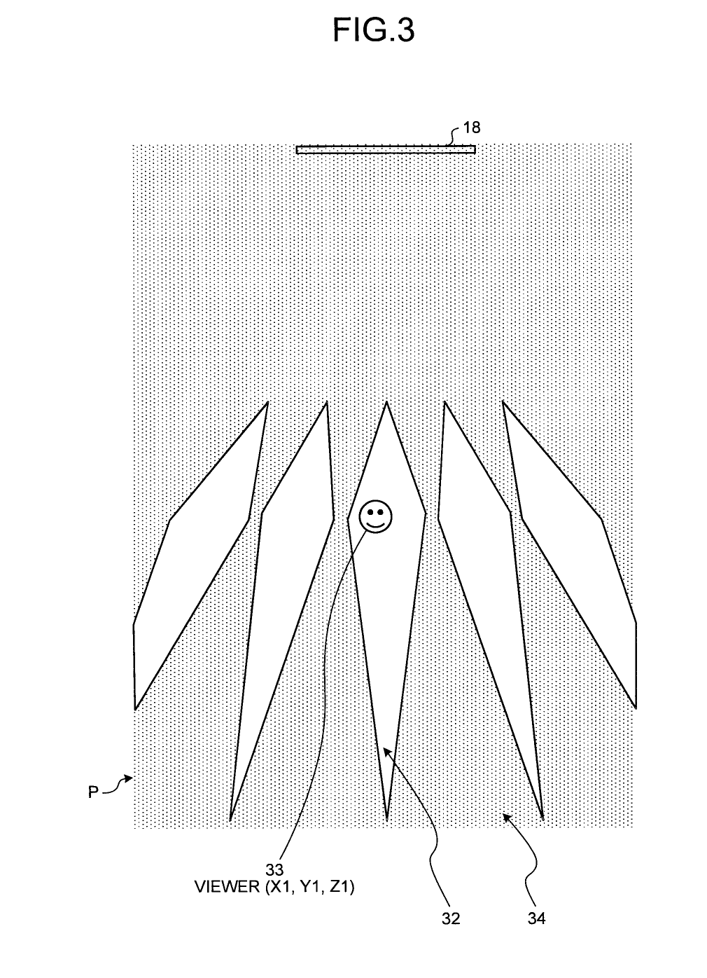

Next, the viewing zone that is determined on the basis of a combination of display parameters of the displaying device 18 will be described more specifically. FIG. 3 is a schematic diagram illustrating an example of the viewing zone with a certain combination of display parameters. FIG. 3 illustrates a state in which the displaying device 18 and a viewable area P are looked down from the upper side. The viewable area P is an area in which the viewer 33 can view an image displayed on the displaying device 18. In FIG. 3, a plurality of white rectangular areas are viewing zones 32. On the other hand, a shaded area is a reverse-viewing zone 34 that is a range outside the viewing zone. In the reverse-viewing zone 34, it is difficult to view a good stereoscopic image due to the occurrence of reverse viewing, crosstalk, and the like.

In the example of FIG. 3, since the viewer 33 is present within the viewing zone 32, the viewer 33 can view a stereoscopic image well.

These viewing zones 32 are set on the basis of a combination of the display parameters of the displaying device 18. Referring back to FIG. 2, examples of the display parameters include a relative position between the display element 20 and the opening controller 26, a distance between the display element 20 and the opening controller 26, the angle of the displaying device 18, the deformation of the displaying device 18, the pitch of pixels in the display element 20, and the like.

The relative position between the display element 20 and the opening controller 26 represents the position of a corresponding element image 30 relative to the center of the opening portion of the opening controller 26. The distance between the display element 20 and the opening controller 26 represents a shortest distance between the opening portion of the opening controller 26 and the element image 30 corresponding thereto. The angle of the displaying device 18 represents a rotation angle with respect to a reference position set in advance when the displaying device 18 is rotated in the vertical direction as a rotation axis. The deformation of the displaying device 18 represents the deformation of the main body of the displaying device 18. The pitch of the pixels of the display element 20 represents an interval between pixels of each element image 30 of the display element 20. In accordance with the combination of the display parameters, an area is uniquely determined in which the viewing zone 32 is set in the real space.

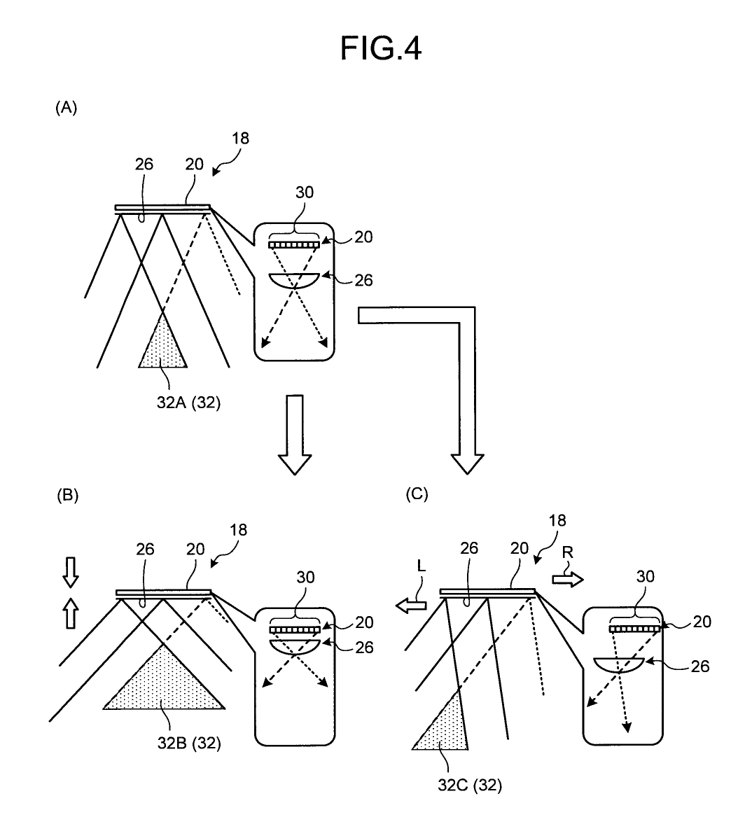

FIGS. 4 to 7 are diagrams illustrating the control of a set position and a set range of the viewing zone 32 through the adjustment of the display parameters of the displaying device 18.

In FIGS. 4 to 7, the relation between the display element 20 and the opening controller 26 in the displaying device 18, and the viewing zone 32 is illustrated. In FIGS. 4 to 7, the portion of each element image 30 is appropriately shown on an enlarged scale.

First, a case will be described with reference to FIG. 4 in which the set position of the viewing zone 32 and the like are controlled through the adjustment of the distance between the display element 20 and the opening controller 26 and the relative position between the display element 20 and the opening controller 26.

FIG. 4(A) illustrates the basic positional relation between the displaying device 18 and the viewing zone 32 (viewing zone 32A). FIG. 4(B) illustrates a case where the distance between the display element 20 and the opening controller 26 is shorter than that illustrated in FIG. 4(A).

As illustrated in FIGS. 4(A) and 4(B), as the distance between the display element 20 and the opening controller 26 is shortened, the viewing zone 32 can be set at a position closer to the displaying device 18 (see the viewing zone 32A shown in FIG. 4(A) and a viewing zone 32B shown in FIG. 4(B)). In contrast, as the distance between the display element 20 and the opening controller 26 is lengthened, the viewing zone 32 can be set at a position located farther from the displaying device 18. Incidentally, as the viewing zone 32 is set to a position closer to the displaying device 18, the density of the light beams decreases.

FIG. 4(C) illustrates a case where the relative position of the display element 20 with respect to the opening controller 26 is moved to the right side (see the direction of an arrow R shown in FIG. 4(C)) from that illustrated in FIG. 4(A). As illustrated in FIGS. 4(A) and 4(C), when the display element 20 is moved to the right side relative to the opening controller 26, the viewing zone 32 moves to the left side (the direction of an arrow L shown in FIG. 4(C)) (see a viewing zone 32C shown in FIG. 4(C)). In contrast, when the relative position of the display element 20 with respect to the opening controller 26 is moved to the left side relative to that shown in FIG. 4(A), the viewing zone 32 moves to the right side (not illustrated in the figure).

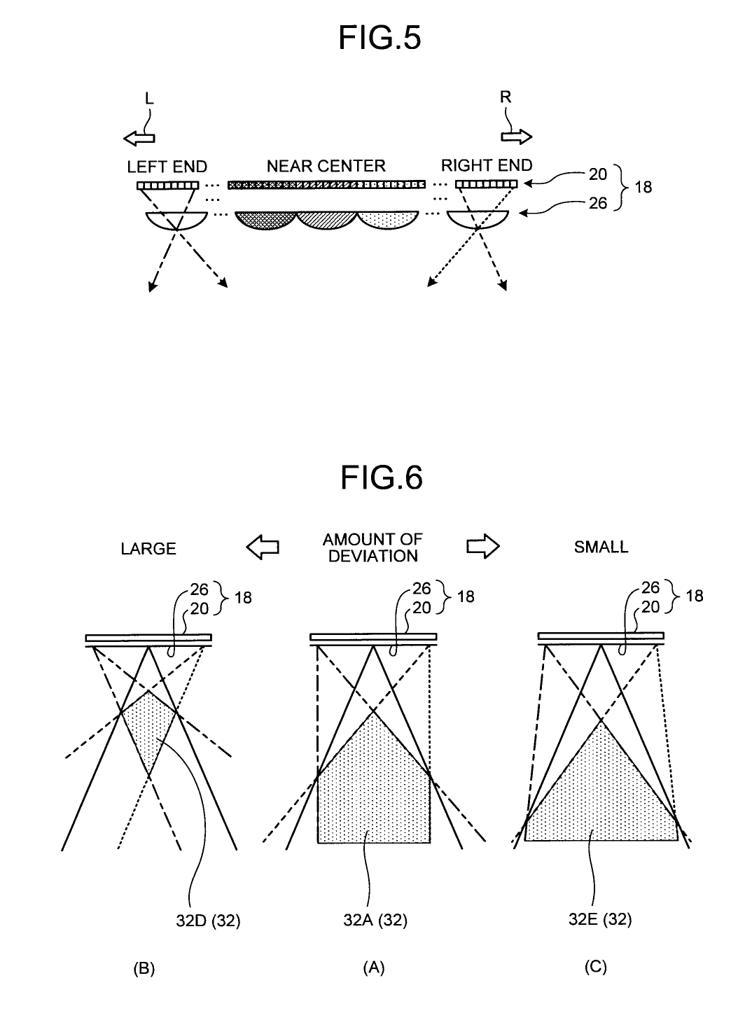

Next, a case will be described with reference to FIGS. 5 and 6 in which the position and the like of the viewing zone 32 are set by adjusting the pitch of the pixels (alignment of the pixels) to be displayed in the display element 20.

FIG. 5 illustrates each pixel of the display element 20 and the opening controller 26 of the displaying device 18 in an enlarged scale. FIG. 6(A) illustrates the basic positional relation between the displaying device 18 and the viewing zone 32 (viewing zone 32A). The closer to ends of the viewing surface of the display element 20 (a right end (an end portion in the direction of an arrow R shown in FIG. 5) and a left end (an end portion in the direction of an arrow L shown in FIG. 5)), the more the positions of each pixel of the display element 20 and the opening controller 26 are relatively deviated. Then, the viewing zone 32 is moved to a position closer to the displaying device 18, and, the width of the viewing zone 32 decreases further (see a viewing zone 32D shown in FIG. 6(B)). Incidentally, the width of the viewing zone 32 represents the maximum length of each viewing zone 32 in the horizontal direction. There is a case where the width of the viewing zone 32 is called a viewing zone setting distance.

On the other hand, the closer to the ends of the viewing surface of the display element 20, the more the amount of the relative deviation between the positions of each pixel of the display element 20 and the opening controller 26 decreases. Then, the viewing zone 32 is moved to a position farther from the displaying device 18, and the width of the viewing zone 32 increases further (see a viewing zone 32E shown in FIG. 6(C)).

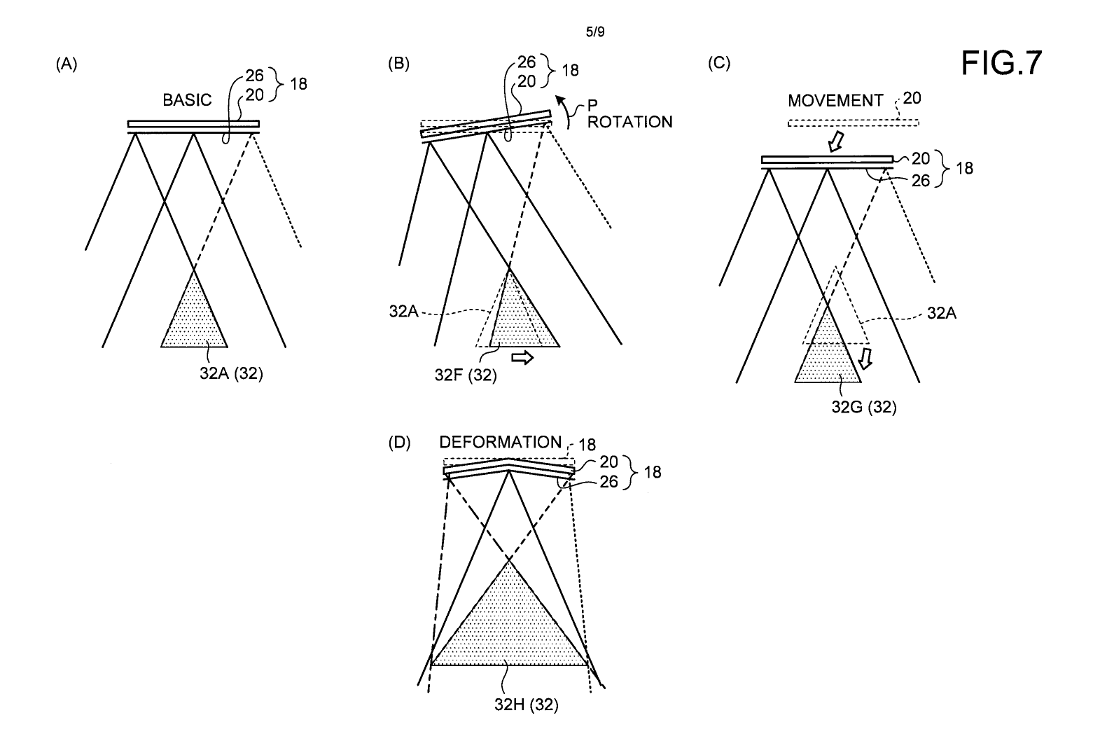

Next, a case will be described with reference to FIG. 7 in which the set position of the viewing zone 32 and the like are controlled through the adjustment of the angle of the displaying device 18, the deformation of the displaying device 18, and the relative position between the display element 20 and the opening controller 26.

FIG. 7(A) illustrates the basic positional relationship between the displaying device 18 and the viewing zone 32 (viewing zone 32A). FIG. 7(B) illustrates a state in which the displaying device 18 is rotated (in the direction of an arrow P shown in FIG. 7). As illustrated in FIGS. 7(A) and 7(B), when the displaying device 18 is rotated so as to adjust the angle of the displaying device 18, the position of the viewing zone 32 is moved from the viewing zone 32A to the viewing zone 32F.

FIG. 7(C) illustrates a state in which the position and the direction of the display element 20 with respect to the opening controller 26 are adjusted. As illustrated in FIG. 7(C), when the position and the direction of the display element 20 with respect to the opening controller 26 are changed, the viewing zone 32 is moved from the viewing zone 32A to the viewing zone 32G.

FIG. 7(D) illustrates a state in which the whole displaying device 18 is deformed. As illustrated in FIGS. 7(A) and 7(D), by deforming the displaying device 18, the viewing zone 32 is changed from the viewing zone 32A to a viewing zone 32H.

As described above, the area (the position, the size, and the like) in which the viewing zone 32 is set in the real space is uniquely determined on the basis of the combination of the display parameters of the displaying device 18.

Referring back to FIG. 1, when a start signal is received from the receiver 12, the calculator 14 calculates, on the basis of position information representing the position of the viewer 33, viewing zone information that represents a viewing zone in which a viewer 33 can view a stereoscopic image.

The position information representing the position of the viewer 33 is represented by positional coordinates in the real space. For example, in the real space, the center of the display surface of the displaying device 18 is set as the origin point, an X axis is set in the horizontal direction, a Y axis is set in the vertical direction, and a Z axis is set in the direction of the normal line of the display surface of the displaying device 18. However, the method of setting the coordinates in the real space is not limited thereto. In addition, on the premise described above, the position information of the position of the viewer 33 that is illustrated in FIG. 3 is denoted by (X1, Y1, Z1). Incidentally, in this embodiment, the position information representing the position of the viewer 33 is stored in advance in a storage medium such as a memory (not illustrated in the figure). In other words, the calculator 14 acquires the position information from the memory.

The position information of the viewer that is stored in the memory, for example, may be information that represents a representative position of the viewer 33 at the time of using the image processing apparatus 10, a position that is registered in advance by the viewer 33, a position of the viewer 33 at the time of the latest completion of the usage of the image processing apparatus 10, a position that is preset in the manufacturing process, or the like. In addition, the position information is not limited thereto and may be a combination of such information.

It is preferable that this position information be position information that represents the position within the viewable area P (see FIG. 3). The viewable area P is determined on the basis of the configuration of each displaying device 18. Incidentally, information that represents the viewable area P is stored in advance in a storage medium such as a memory (not illustrated in the figure) as well.

When a start signal is received from the receiver 12, the calculator 14 calculates viewing zone information that represents a viewing zone in which a stereoscopic image can be viewed at the position of the viewer 33 that is represented by the position information. In the calculation of the viewing zone information, for example, the viewing zone information that represents the viewing zone 32 corresponding to a combination of the display parameters described above is stored in a memory (not illustrated in the figure) in advance. Then, the calculator 14 searches the memory for the viewing zone information in which the position information representing the position of the viewer 33 is included in the viewing zone 32, thereby calculating the viewing zone information.

Incidentally, the calculator 14 may calculate the viewing zone information through calculation. In such a case, the calculator 14 stores a calculation equation used for calculating the viewing zone information on the basis of the position information in a memory (not illustrated in the figure) in advance such that the position information representing the position of the viewer 33 is included in the viewing zone 32. Then, the calculator 14 calculates the viewing zone information by using the position information and the calculation equation.

Furthermore, when there is a plurality of viewers 33 (when the position information represents a plurality of viewing zones 32), it is preferable that the calculator 14 calculate the viewing zone information such that more viewers 33 are included in the viewing zone 32.

The controller 16 controls the displaying device 18 so as to set the viewing zone 32 corresponding to the viewing zone information calculated by the calculator 14. In other words, the controller 16 adjusts the display parameters of the displaying device 18, thereby setting the viewing zone 32. More particularly, in the displaying device 18, a driving unit, which is not illustrated in the figure, used for adjusting the above-described display parameters is disposed. In addition, the controller 16 stores the viewing zone information that represents the viewing zone 32 corresponding to a combination of the above-described display parameters in a memory (not illustrated in the figure) in advance. Then, the controller 16 fetches the combination of the display parameters corresponding to the viewing zone information calculated by the calculator 14 from the memory and controls the driving unit corresponding to each fetched display parameter.

Accordingly, the displaying device 18 displays a stereoscopic image for the viewing zone 32 corresponding to the viewing zone information calculated by the calculator 14.

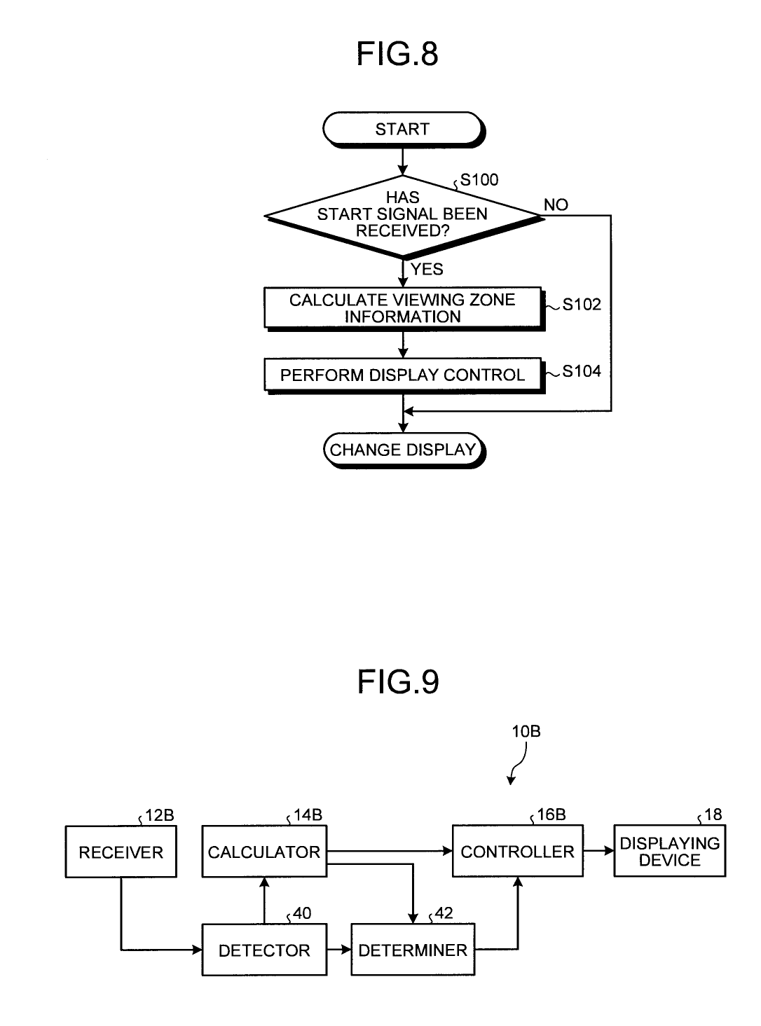

Next, a display control process performed by the image processing apparatus 10, which is configured as described above, according to this embodiment will be described with reference to a flowchart illustrated in FIG. 8.

The receiver 12 determines whether or not a start signal has been received. When the receiver 12 determines that a start signal has not been received, this routine ends (No in Step S100). When the receiver 12 determines that a start signal has been received (Yes in Step S100), the calculator 14 calculates the viewing zone information on the basis of the position information of the viewer 33 (Step S102).

The controller 16 controls the displaying device 18 so as to set the viewing zone 32 corresponding to the viewing zone information calculated by the calculator 14 (Step S104). Then, this routine ends.

As described above, in the image processing apparatus 10 according to this embodiment, when the receiver 12 receives a start signal used for staring to set the viewing zone, the calculator 14 calculates, on the basis of the position information of the viewer 33, the viewing zone information that represents a viewing zone 32 in which a stereoscopic image can be viewed at the position of the viewer 33. Then, the controller 16 controls the displaying device 18 so as to set the viewing zone 32 corresponding to the calculated viewing zone information.

Thus, in the image processing apparatus 10 according to this embodiment, the setting (including the changing) of the viewing zone 32 is not always performed, but the viewing zone 32 is set when the receiver 12 receives a start signal of the viewing zone 32. Accordingly, a possibility that, during a period other than the time at which a start signal is received, the viewing zone 32 changes due to a malfunction or the like during the viewing of a stereoscopic image so as to allow the viewer 33 to recognize the reverse-viewing state can be reduced. In addition, in the image processing apparatus 10 according to this embodiment, the calculator 14 calculates, on the basis of the position information of the viewer 33, the viewing zone information that represents a viewing zone in which a stereoscopic image can be viewed by the viewer 33. Accordingly, it can be suppressed that viewing zone 32 is set to a position deviated from the position of the viewer 33.

Therefore, in the image processing apparatus 10 according to this embodiment, the viewer 33 can view a good stereoscopic image easily.

### Second Embodiment

In a second embodiment, a detector detects the position of a viewer 33. In addition, according to the second embodiment, a determiner is included which determines whether or not a viewing zone is changed.

FIG. 9 is a block diagram illustrating the functional configuration of an image processing apparatus 10B according to the second embodiment. The image processing apparatus 10B according to this embodiment, as illustrated in FIG. 9, includes a receiver 12B, a calculator 14B, a controller 16B, a displaying device 18, a detector 40, and a determiner 42.

The displaying device 18 is similar to that according to the first embodiment. The receiver 12B, similarly to the receiver 12 described in the first embodiment, receives a start signal from an external device (not illustrated in the figure) that is connected to the receiver 12B in a wired or wireless manner. In this embodiment, the receiver 12B supplies a signal representing the received start signal to the detector 40.

The detector 40 detects the position of the viewer 33 in a real space within the viewable area P (see FIG. 2). In this embodiment, the detector 40 detects the position of the viewer 33 when the receiver 12B receives a start signal.

The detector 40 may be a device that can detect the position of the viewer 33 in the real space within the viewable area P. For example, as the detector 40, a device such as an imaging device including a visible-ray camera and an infrared camera, a radar, or a sensor can be used. In such a device, the position of the viewer 33 is detected by using a known technique on the basis of the acquired information (the photographed image in the case of a camera).

For example, when the visible-ray camera is used as the detector 40, the detector 40 performs the detection of a viewer 33 and the calculation of the position of the viewer 33 by performing image analysis of an image acquired through imaging. Accordingly, the detector 40 detects the position of the viewer 33. In addition, when the radar is used as the detector 40, the detector 40 performs the detection of the viewer 33 and the calculation of the position of the viewer 33 by performing signal processing of an acquired radar signal. Therefore, the detector 40 detects the position of the viewer 33.

In addition, when the position of the viewer 33 is detected, the detector 40 may detect an arbitrary target portion such as the face, the head, or the whole body of the viewer 33, a marker, or the like that can be used for determining that it is a person. The method of detecting the arbitrary target portion may be performed by using a known technique.

Then, the detector 40 supplies a signal representing a detection result that includes the position information of the viewer 33 to the calculator 14B and the determiner 42. In addition to the position information of the viewer 33, the detector 40 may output a signal that represents a detection result including feature information representing the features of the viewer 33 to the calculator 14B. As such feature information, for example, there is information that is set by setting the feature points of the face of the viewer 33 or the like as extraction targets in advance.

The calculator 14B calculates, on the basis of the position information representing the position of the viewer 33 that is included in the signal representing the detection result received from the detector 40, the information of the viewing zone in which the viewer 33 can view a stereoscopic image. The method of calculating the viewing zone information is similar to that used by the calculator 14 according to the first embodiment. The calculator 14B performs the calculation of the viewing information when the signal representing the detection result is received from the detector 40.

Incidentally, when the feature information is included in the signal representing the detection result received from the detector 40, the calculator 14B may calculate the viewing zone information such that at least a specific viewer 33 set in advance is included in the viewing zone 32. The specific viewer 33 is a viewer 33 having a feature such as a viewer 33 registered in advance or a viewer having a specific external device used for transmitting the start signal, which is different from that of any other viewer 33. In such a case, for example, the calculator 14B stores the feature information of one or a plurality of specific viewers 33 in a memory, which is not illustrated in the figure, in advance. Then, the calculator 14B fetches feature information that coincides with the feature information that is stored in the memory in advance out of the feature information included in the signal representing the detection result received from the detector 40. Then, the calculator 14B extracts the position information of the viewer 33 corresponding to the fetched feature information from the detection result and calculates, on the basis of the extracted position information, the information of the viewing zone in which a stereoscopic image can be viewed at the position of the position information.

The determiner 42 determines whether or not the viewing zone 32 is set (the viewing zone is changed from the current viewing zone 32) on the basis of the position information of the viewer 33 that is detected by the detector 40. The current viewing zone 32 represents a viewing zone 32 that is implemented (set) through the current combination of the display parameters of the displaying device 18. In addition, the “current” represents the time when the signal representing the start signal is received by the receiver 12B.

The determiner 42 makes the determination as below. More specifically, it is assumed that the position of the position information of the viewer 33 is within the range of the viewing zone 32 that is currently set by the displaying device 18. In a case where the position of the viewer 33 is beyond the range of the viewing zone when the current viewing zone 32 is changed, the determiner 42 determines that the setting (changing) of the viewing zone is not performed. The determination whether or not the position of the viewer 33 is beyond the range of the viewing zone 32 when the current viewing zone 32 is changed, for example, may be performed as below. More specifically, the determiner 42 calculates the viewing zone information similarly to a calculator 14C to be described later on the basis of the position information included in the detection result received from the detector 40. Then, the determiner 42 makes the determination by determining whether or not the position of the position information is included inside the viewing zone 32 of the calculated viewing zone information.

In addition, the determiner 42 determines that the setting (changing) of the viewing zone is not performed in a case where the position information of the viewer 33, which is detected by the detector 40, represents the outside of the viewable area P. The reason for this is that the viewer 33 is present outside the viewable area P in which the displaying device 18 can be viewed. The determination whether or not the position information represents the outside of the viewable area P is performed by storing information (for example, a set of positional coordinates) representing the viewable area P in a memory, which is not illustrated in the figure, in advance and determining whether or not the position information included in the signal representing the detection result, which is received from the detector 40, is outside the viewable area P by using the determiner 42.

The determiner 42 supplies a signal that represents the determination result to the controller 16B. The signal representing this determination result is information that represents that there is a change or no change in the viewing zone.

When the signal representing the determination result received from the determiner 42 is the information that represents that there is a change in the viewing zone, the controller 16B controls the displaying device 18 so as to set the viewing zone 32 corresponding to the viewing zone information calculated by the calculator 14B. The controller 16B, similarly to the first embodiment, adjusts the display parameters of the displaying device 18 so as to set the viewing zone 32. Accordingly, the displaying device 18 displays a stereoscopic image in the viewing zone 32 corresponding to the viewing zone information calculated by the calculator 14.

On the other hand, when the determination result received from the determiner 42 is the information that represents that there is no change in the viewing zone, the controller 16B maintains the viewing zone 32 that has already been set. Alternatively, the controller 16B controls the displaying device 18 so as to set the viewing zone 32 to be in a reference state. Here, the reference state may be a state that is based on recommended parameters set in a manufacturing stage.

In other words, when the determiner 42 determines that there is a change in the viewing zone, the controller 16B controls the displaying device 18 so as to change the current viewing zone 32. On the other hand, when the determiner 42 determines that there is no change in the viewing zone, the controller 16B controls the displaying device 18 so as to maintain the viewing zone 32 that has already been set or set to be in the reference state.

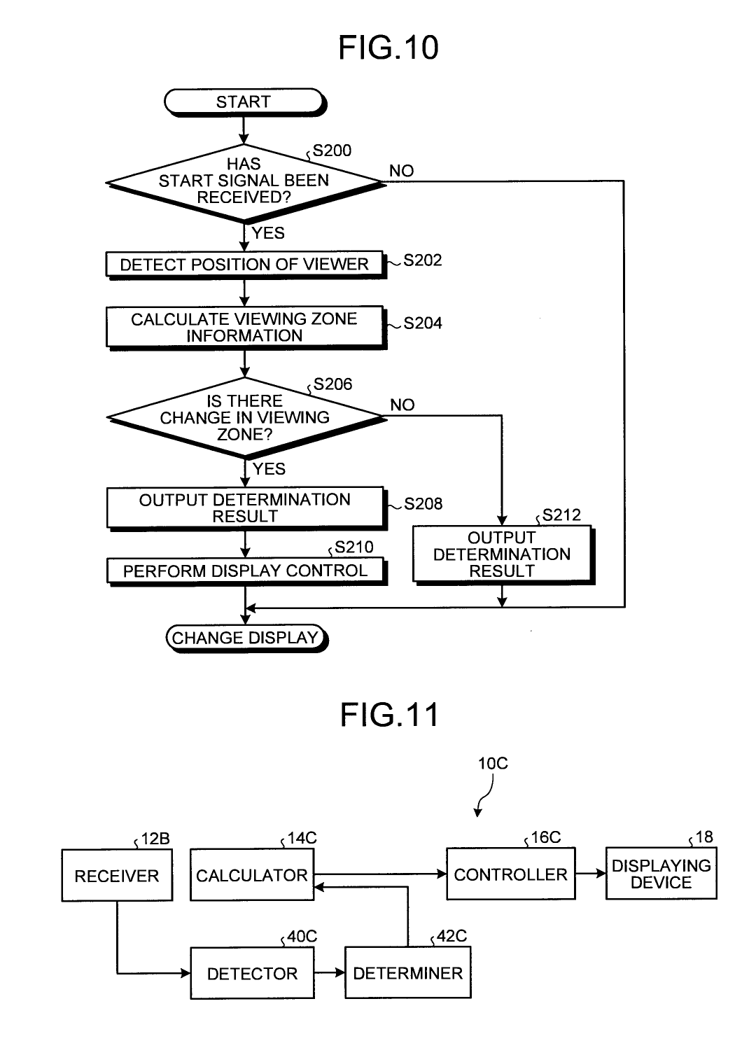

Next, a display control process performed by the image processing apparatus 10B, which is configured as described above, according to this embodiment will be described with reference to a flowchart illustrated in FIG. 10.

The receiver 12B determines whether or not a start signal has been received (Step S200). When the receiver 12B determines that a start signal has not been received, this routine ends (No in Step S200). When the receiver 12B determines that a start signal has been received (Yes in Step S200), the detector 40 detects the position of the viewer 33 (Step S202). Then, the detector 40 supplies a signal representing the detection result to the calculator 14B.

When the signal representing the detection result is received from the detector 40, the calculator 14B calculates the viewing zone information on the basis of the position information of the viewer 33 that is included in the signal representing the detection result (Step S204). The calculator 14B supplies the calculated viewing zone information to the determiner 42 and the controller 16B.

The determiner 42 determines whether or not the viewing zone 32 is set (changed from the current viewing zone 32) (Step S206). The determiner 42 supplies the determination result to the controller 16B.

In a case where the determiner 42 determines that there is a change in viewing zone (Yes in Step S206), the controller 16B outputs the determination result (Step S208). More specifically, the controller 16B displays information representing that there is a change in the viewing zone as the determination result on the displaying device 18. Incidentally, in this embodiment, a case will be described in which the controller 16B displays information representing the determination result of the determiner 42 on the displaying device 18 in Step S208 and Step S212 to be described later. However, the output destination of this determination result is not limited to the displaying device 18. For example, the controller 16B may output the determination result to a display device other than the displaying device 18 or a known audio output device. Furthermore, the controller 16B may output the determination result to an external device that is connected to the controller 16B in a wired or wireless manner.

The controller 16B controls the displaying device 18 so as to set the viewing zone 32 corresponding to the viewing zone information calculated by the calculator 14B (Step S210). The control of the displaying device 18 by using the controller 16B is similar to that of the first embodiment. Then, this routine ends.

On the other hand, when the determiner 42 determines that there is no change in the viewing zone (No in Step S206), the controller 16B outputs information representing that there is no change in the viewing zone as the determination result (Step S212). Then, this routine ends.

Incidentally, when the image processing apparatus 10B is used for the first time, in Step S201, the determiner 42 may be designed in advance so as to determine “Yes”.

As described above, in the image processing apparatus 10B according to this embodiment, the position of the viewer 33 is detected by the detector 40, and the calculator 14B calculates the viewing zone information on the basis of the detected position information. Accordingly, the position of the viewer 33 can be acquired more accurately.

In addition, in the image processing apparatus 10B according to this embodiment, the determiner 42 determines whether or not the current viewing zone 32 is changed. Then, in a case where the determiner 42 determines that there is a change in the viewing zone, the controller 16B controls the displaying device 18 so as to change the current viewing zone 32. On the other hand, in a case where the determiner 42 determines that there is no change in the viewing zone, the controller 16B controls the displaying device 18 so as to maintain the viewing zone 32 that has already been set or to set to be in the reference state.

Accordingly, by making the above-described determination by using the determiner 42, it can be suppressed that the viewing zone 32 is unnecessarily changed or the viewing zone 32 is set so as to degrade the a stereoscopic image viewing situation for the viewer 33.

### Third Embodiment

FIG. 11 is a block diagram illustrating the functional configuration of an image processing apparatus 10C according to a third embodiment. The image processing apparatus 10C according to this embodiment, as illustrated in FIG. 11, includes a receiver 12B, a calculator 14C, a controller 16C, a displaying device 18, a detector 40C, and a determiner 42C.

The receiver 12B, the calculator 14C, the controller 16C, the displaying device 18, the detector 40C, and the determiner 42C are similar to the receiver 12B, the calculator 14B, the controller 16B, the displaying device 18, the detector 40, and the determiner 42 according to the second embodiment. Incidentally, the following points are different.

In this embodiment, the detector 40C supplies a signal representing the detection result of the position of the viewer 33 to the determiner 42C. When the signal representing the detection result is received, the determiner 42C determines whether or not the viewing zone 32 is set (changed from the current viewing zone 32). Then, the determiner 42C supplies a signal representing the determination result to the calculator 14C. In a case where the signal representing the determination result received from the determiner 42C represents that there is a change in the viewing zone, the calculator 14C calculates the viewing zone information. Then, in a case where a signal representing the calculation result of the viewing zone information is received from the calculator 14C, the controller 16C controls the displaying device 18. Such points are different from those of the second embodiment.

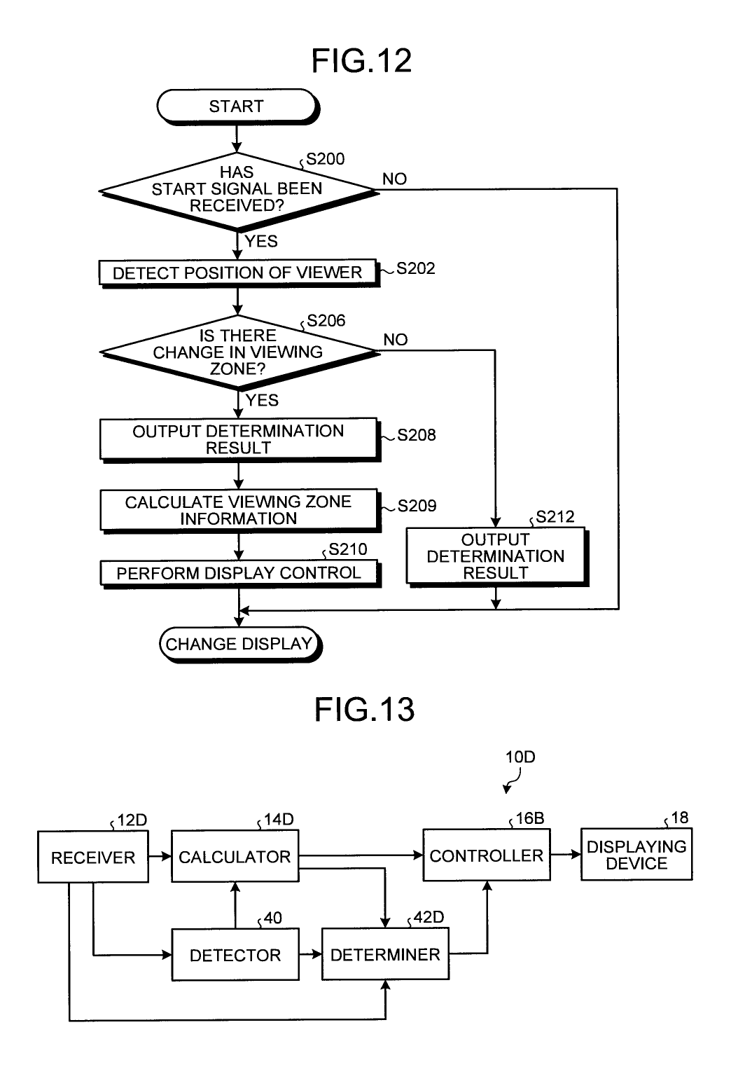

Next, a display control process performed by the image processing apparatus 10C, which is configured as described above, according to this embodiment will be described with reference to a flowchart illustrated in FIG. 12. This embodiment is similar to the second embodiment except that the calculation of the viewing zone information, which is performed by the calculator 14B, is performed after a determination is made by the determiner 42C. Thus, the same reference numerals are assigned to the same processes as those of the second embodiment, and detailed description thereof will not be presented.

When the receiver 12B determines whether or not a start signal has been received and determines that the start signal has been received, the detector 40C detects the position of the viewer 33 (Step S200, Yes in Step S200, and Step S202). When the determiner 42C determines whether or not the viewing zone 32 is set (changed from the current viewing zone 32) and determines that there is a change in the viewing zone, the controller 16C outputs information representing that there is a change in the viewing zone as a determination result (Step S206, Yes in Step S206, and Step S208). Incidentally, when the receiver 12B determines that a start signal has not been received (No in Step S200), this routine ends.

When the signal representing that there is a change in the viewing zone is received from the determiner 42C, the calculator 14C calculates the viewing zone information on the basis of the position information of the viewer 33 that is included in the detection result of the detector 40C (Step S209). The detector 40C supplies the calculated viewing zone information to the controller 16C. Next, the controller 16C controls the displaying device 18 so as to set a viewing zone 32 corresponding to the viewing zone information calculated by the calculator 14C (Step S210). Then, this routine ends.

On the other hand, when the determiner 42C determines that there is no change in the viewing zone (No in Step S206), the controller 16C outputs information representing that there is no change in the viewing zone as a determination result (Step S212). Then, this routine ends.

As described above, in the image processing apparatus 10C according to this embodiment, the determiner 42C determines whether or not the current viewing zone 32 is changed. Then, in a case where the determiner 42C determines that there is a change in the viewing zone, the calculator 14C calculates the viewing zone information.

Thus, according to the image processing apparatus 10C of this embodiment, it can be suppressed that the viewing zone 32 is unnecessarily changed or the viewing zone 32 is changed so as to degrade the stereoscopic image viewing situation for the viewer 33.

### Fourth Embodiment

FIG. 13 is a block diagram illustrating the functional configuration of an image processing apparatus 10D according to a fourth embodiment. The image processing apparatus 10D according to this embodiment, as illustrated in FIG. 13, includes a receiver 12D, a calculator 14D, a controller 16B, a displaying device 18, a detector 40, and a determiner 42D.

The receiver 12D, the calculator 14D, the controller 16B, the displaying device 18, the detector 40, and the determiner 42D are similar to the receiver 12B, the calculator 14B, the controller 16B, the displaying device 18, the detector 40, and the determiner 42 according to the second embodiment. Incidentally, the following points are different.

In this embodiment, the receiver 12D supplies a received start signal to the calculator 14D, the detector 40, and the determiner 42D. The calculator 14D receives the start signal from the receiver 12D and, in a case where a signal representing a detection result is received from the detector 40, calculates the viewing zone information similarly to the second embodiment. The determiner 42D receives the start signal from the receiver 12D and, in a case where a signal representing a detection result is received from the detector 40, makes a determination similarly to the second embodiment. Such points are different from those of the second embodiment.

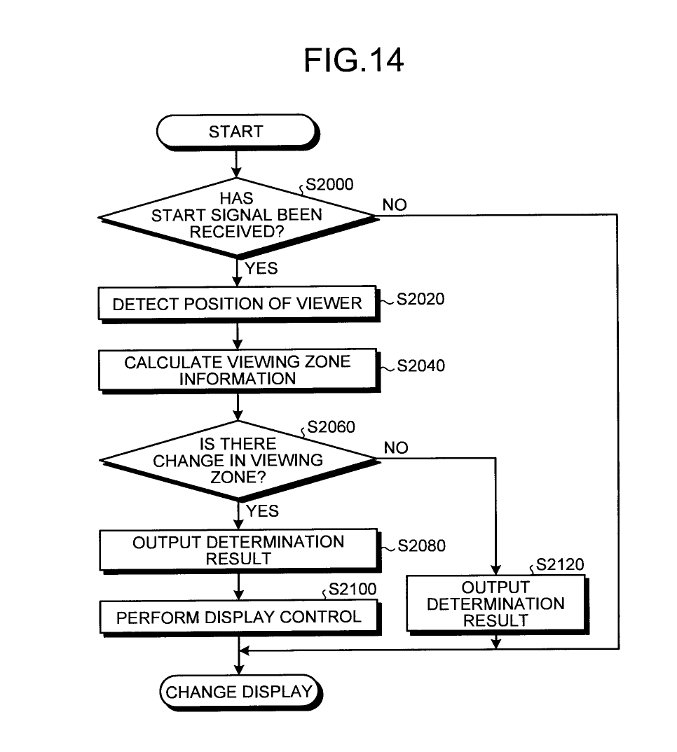

Next, a display control process performed by the image processing apparatus 10D, which is configured as described above, according to this embodiment will be described with reference to a flowchart illustrated in FIG. 14.

The receiver 12D determines whether or not a start signal has been received (Step S2000). In a case where the receiver 12D determines that a start signal has not been received, this routine ends (No in Step S2000). In a case where the receiver 12D determines that a start signal has been received (Yes in Step S2000), the receiver 12D supplies the start signal to the calculator 14D, the determiner 42D, and the detector 40. The detector 40 detects the position of the viewer 33 (Step S2020). Then, the detector 40 supplies a detection result to the calculator 14D and the determiner 42D.

When the start signal is received from the receiver 12D, and the detection result is received from the detector 40, the calculator 14D calculates the viewing zone information on the basis of the position information of the viewer 33 that is included in the detection result (Step S2040). The detector 40 supplies the calculated viewing zone information to the determiner 42D and the controller 16B.

When the start signal is received from the receiver 12D, the signal representing the detection result is received from the detector 40, and the viewing zone information is received from the calculator 14D, the determiner 42D determines whether or not the viewing zone 32 is set (changed from the current viewing zone 32) (Step S2060). The determiner 42D supplies a signal representing the determination result to the controller 16B.

In a case where the determiner 42D determines that there is a change in the viewing zone (Yes in Step S2060), the controller 16B outputs information representing that there is a change in the viewing zone as the determination result (Step S2080). Incidentally, the process of this Step S2080 is similar to Step S208 of the second embodiment.

Next, the controller 16B controls the displaying device 18 so as to set the viewing zone 32 corresponding to the viewing zone information calculated by the calculator 14D (Step S2100). The control of the displaying device 18 by using this controller 16B is similar to that of the second embodiment. Then, this routine ends.

On the other hand, in a case where the determiner 42D determines that there is no change in the viewing zone (No in Step S2060), the controller 16B outputs information representing that there is no change in the viewing zone as the determination result (Step S2120). Then, this routine ends.

As described above, in the image processing apparatus 10D according to this embodiment, in a case where a start signal is received from the receiver 12D, the position of the viewing zone 32 is detected by the detector 40, the viewing zone information is calculated by the calculator 14D, and a determination is made by the determiner 42D.

Accordingly, in the image processing apparatus 10D according to this embodiment, when the start signal is received by the receiver 12D, the viewing zone 32 can be changed.

Incidentally, image processing programs used for performing the display control processes that are performed by the image processing apparatuses 10, 10B, 10C, and 10D according to the first to fourth embodiments are provided with being built in a ROM or the like in advance.

The image processing programs performed by the image processing apparatuses 10, 10B, 10C, and 10D according to the first to fourth embodiments may be configured so as to be provided by recording them on computer-readable recording media such as a CD-ROM, a flexible disk (FD), a CD-R, and a digital versatile disk (DVD) as a file having an installable format or an executable format.

In addition, the image processing programs performed by the image processing apparatuses 10, 10B, 10C, and 10D according to the first to fourth embodiments may be configured so as to be provided by storing them on a computer connected to a network such as the Internet and downloading them through the network. In addition, the image processing programs performed by the image processing apparatuses 10, 10B, 10C, and 10D according to the first to fourth embodiments may be configured to be provided or distributed through a network such as the Internet.

The image processing programs performed by the image processing apparatuses 10, 10B, 10C, and 10D according to the first to fourth embodiments are configured as modules including the above-described units (the receiver, the calculator, the controller, the detector, the determiner, and the displaying device), and, as actual hardware, the CPU (processor) reads out the image processing programs from the ROM and executes the image processing programs, whereby the above-described units are loaded into a main memory device so as to generate the receiver, the calculator, the controller, the displaying device, the detector, and the determiner in the main memory device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a displaying device that can display a stereoscopic image;
a receiver that receives a start signal used for starting setting a viewing zone in which the stereoscopic image can be viewed by a viewer;
a calculator that calculates, on the basis of position information of the viewer, viewing zone information representing a position of the viewing zone when the start signal is received; and
a controller that controls the displaying device such that the viewing zone corresponding to the viewing zone information is set.

2. The image processing apparatus according to claim 1, further comprising a detector that detects a position of the viewer,
wherein the calculator acquires the position information from the detector.

3. The image processing apparatus according to claim 1, further comprising a determiner that determines, on the basis of the position information, whether to set the viewing zone or not,
wherein the controller controls the displaying device so as to set the viewing zone in a case where it is determined to set the viewing zone.

4. The image processing apparatus according to claim 1, further comprising a determiner that determines, on the basis of the position information, whether to calculate the viewing zone or not,
wherein the calculator calculates the viewing zone information in a case where it is determined to calculate the viewing zone.

5. The image processing apparatus according to claim 1, further comprising a storage device that stores the position information of the viewer,
wherein the calculator acquires the position information from the storage device.

6. A method of processing an image, the method comprising:
receiving a start signal used for starting setting a viewing zone in which a stereoscopic image displayed on a displaying device can be viewed by a viewer;
calculating, on the basis of position information of the viewer, viewing zone information representing a position of the viewing zone when the start signal is received; and
controlling the displaying device such that the viewing zone corresponding to the viewing zone information is set.
